(19) United States
(12) Patent Application Publication
(10) Pub. No.: US 2010/0027028 A1
(43) Pub. Date: Feb. 4, 2010

(54) Oblique incidence interferometer

(75) Inventors: Yutaka Kuriyama, Tsukuba-shi (JP); Kazuhiko Kawasaki, Tsukuba-shi (JP)

Correspondence Address: OLIFF & BERRIDGE, PLC, P.O. BOX 320850, ALEXANDRIA, VA, 22320-4850, US

(73) Assignee: MITUTOYO CORPORATION, Kawasaki (JP)

(21) Appl. No.: 12/458,461

(22) Filed: Jul. 13, 2009

(30) Foreign Application Priority Data
Jul. 29, 2008 (JP) 2008-194382

(51) Int. Cl. G01B 9/02

(52) U.S. Cl. 356/495

(57) ABSTRACT

An oblique incidence interferometer has favorable measurement accuracy while achieving miniaturization. The oblique incidence interferometer includes a light source that emits coherent light; a beam dividing unit that divides the coherent light from the light source into a measurement beam and a reference beam, polarizing directions of both beams being perpendicular to each other; a first beam folding unit that folds the measurement beam divided by the beam dividing unit to cause the folded measurement beam to be incident on the measurement object surface at a predetermined angle relative to the measurement object surface; a second beam folding unit that folds the measurement beam reflected by the measurement object surface; and a beam combining unit that combines the measurement beam folded by the second beam folding unit with the reference beam.

### BACKGROUND

The present invention relates to an oblique incidence interferometer.

Various interferometers for measuring a surface shape of a workpiece have been known. Among these interferometers, an oblique incidence interferometer that can measure a shape of a measurement object surface that has a wavy or non-mirror surface (rough face) has been known. The oblique incidence interferometer measures a shape of the measurement object surface by irradiating the measurement object surface with coherent light in an oblique direction to the normal of the object surface, causing a measuring beam reflected from the measurement object surface to interfere with a reference beam so as to produce interference fringes, and analyzing the interference fringes.

For example, Japanese Unexamined Laid-Open Patent Application Publication No. 2008-32690 proposes, in such an oblique incidence interferometer, a configuration in which three pieces or more of interference images required for a phase shift method being a general analyzing method of interference fringes, can be simultaneously picked up.

FIG. 4 illustrates a conventional example of such an oblique incidence interferometer 4. The oblique incidence interferometer 4 includes an irradiation unit 100A and a detection unit 300. The irradiation unit 100A includes a light source 101, lenses 102 and 103, a beam dividing element 104, a beam combining element 105, and an element 106 for rotating a polarization plane of incident light. The detection unit 300 includes a quarter wave plate 301, a lens 302, a tripartite prism 303, polarizing plates 304A to 304C, and image pickup devices 305A to 305C.

A beam irradiated from the light source 101 enters the beam dividing element 104 via the lenses 102 and 103 to be divided into two beams. One of the divided beams is caused to irradiate the surface of a measurement object 200 in an oblique direction. Then, the light reflected from the measurement object 200 is combined by the beam combining element 105 with the other beam divided by the beam dividing element 104 and rotated with regard to a polarization plane by the element 106. The combined beam is shifted in phase by an optical system including the quarter wave plate 301, the lens 302, the tripartite prism 303, and the polarizing plates 304A to 304C to produce interference fringes so that the interference fringes are picked up by the image pickup devices 305A to 305C, respectively.

As illustrated in FIG. 5, an oblique incidence interferometer 5 including an irradiation unit 100B having a triangular prism 107 instead of the beam dividing element 104 and the beam combining element 105 also is proposed. On a bottom surface of the triangular prism 107, for example, a wire grid polarizing plate 108 is arranged.

The oblique incidence interferometer 5 irradiates an object with laser light through the triangular prism 107, and causes the light reflected from the polarizing plate 108 on the bottom surface of the triangular prism 107 to interfere with the light reflected from the surface of the measurement object 200.

For background information see, for example, Japanese Unexamined Laid-Open Patent Application Publication No. 2008-32690.

### SUMMARY

However, in the case of the oblique incidence interferometer 4 illustrated in FIG. 4, because it is necessary to arrange the optical elements, such as the light source 101 and the detection unit 300, along an extension of the optical axis of measurement light, increasing the illuminating angle of the light relative to the normal of the measurement object surface, causes the entire apparatus to become longer sideways due to an effect of the size of each optical element, so that a problem arises in that the apparatus becomes larger.

Also, in the case of the oblique incidence interferometer 5 illustrated in FIG. 5, since an extinction ratio of the reference light is not so high, the signal-to-noise ratio of the interference fringe images is low, so that a problem arises in that measurement accuracy is not favorable.

As mentioned above, conventional oblique incidence interferometers have a problem in that it is difficult to improve the measurement accuracy while reducing the size of the apparatus.

It is an object of the present invention to provide an oblique incidence interferometer having favorable measurement accuracy while reducing the size of the apparatus.

In order to address the problems described above there is provided an oblique incidence interferometer that is configured to measure a shape of measurement object surface by irradiating the measurement object surface with coherent light in an oblique direction to a normal of the measurement object surface to cause a measurement beam reflected from the measurement object surface to interfere with a reference beam. The oblique incidence interferometer includes a light source configured to emit the coherent light. The oblique incidence interferometer also includes a beam dividing unit that is configured to divide the coherent light from the light source into the measurement beam and the reference beam, polarizing directions of both beams being perpendicular to each other. In addition, a first beam folding unit is configured to fold the measurement beam divided by the beam dividing unit so as to cause the folded measurement beam to be incident on the measurement object surface at a predetermined angle to the measurement object surface. Further, a second beam folding unit is configured to fold the measurement beam reflected by the measurement object surface toward the reference beam. Additionally, a beam combining unit is configured to combine the measurement beam folded by the second beam folding unit with the reference beam.

The beam dividing unit and the first beam folding unit as well as the beam combining unit and the second beam folding unit can be arranged closely to each other. The measurement beam folded by the first beam folding unit can again pass through the beam dividing unit so as to enter the measurement object surface, and the measurement beam reflected by the measurement object surface is folded by the second beam folding unit after passing through the beam combining unit so as to again enter the beam combining unit.

The beam dividing unit and the first beam folding unit may be included in a single optical component while the beam combining unit and the second beam folding unit may also be included in a single optical component.

The beam dividing unit and the beam combining unit may be polarization beam splitters.

The single optical component may be an optical wedge.

The oblique incidence interferometer may further include a second beam dividing unit that is configured to divide the combined beam combined by the beam combining unit into a plurality of divided beams. Additionally, a plurality of image pickup devices may be configured to pick up a plurality of interference fringe images, respectively, which are respectively formed by the plurality of divided beams. A quarter wave plate can be arranged on the incident side of the second beam dividing unit, and a plurality of polarizing plates may be arranged on the imaging plane sides of the plurality of image pickup devices such that the directions of polarizing axes of the polarizing plates differ from each other.

According to the present invention, the coherent light from the light source can be divided by the beam dividing unit into two beams having polarizing directions that are perpendicular to each other. One of the two beams can be used as a measurement beam and another beam can be used as a reference beam. Dividing the beams can form an optical system so that interference fringes with a high extinction ratio and a high signal-to-noise ratio can be obtained causing measurement to achieve higher accuracy.

Because the first beam folding unit and the second beam folding unit allow an optical path of the measurement beam to be changed, the apparatus can be reduced in size.

Hence, an oblique incidence interferometer that reconciles apparatus miniaturization with measurement accuracy can be obtained.

### BRIEF DESCRIPTION OF THE DRAWINGS

FIG. 1 illustrates an oblique incidence interferometer according to a first embodiment.

FIG. 2 illustrates an oblique incidence interferometer according to a second embodiment.

FIG. 3 illustrates an oblique incidence interferometer according to a third embodiment.

FIG. 4 illustrates a conventional oblique incidence interferometer.

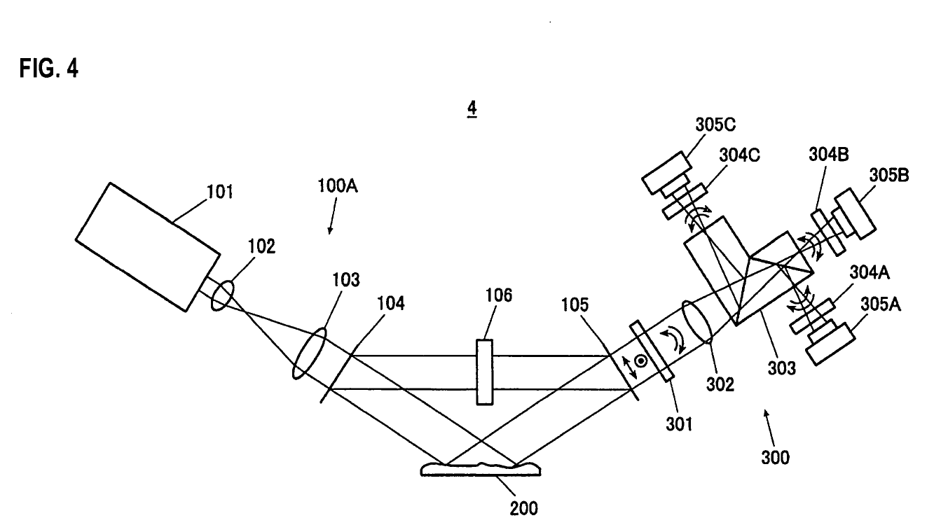

FIG. 5 illustrates a conventional oblique incidence interferometer.

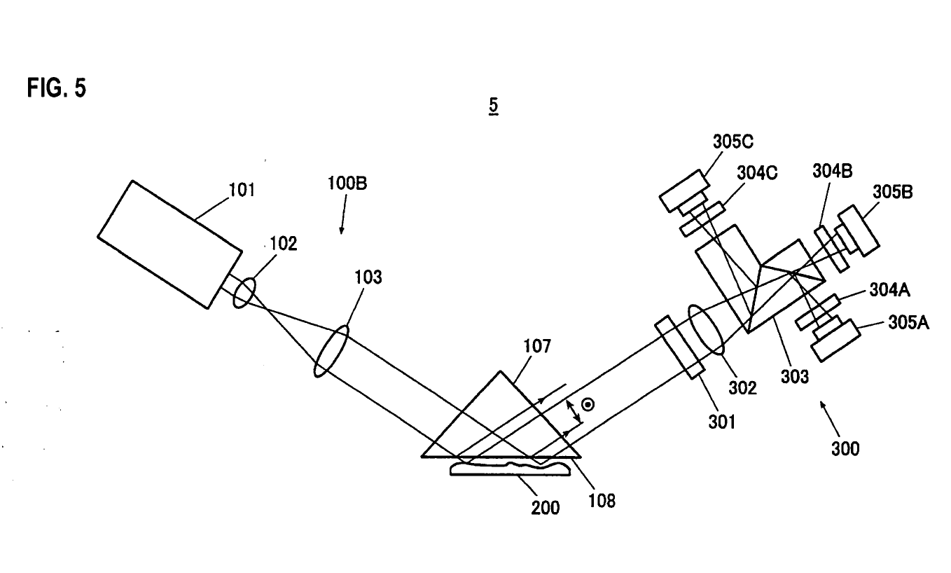

### DETAILED DESCRIPTION OF EMBODIMENTS

Exemplary embodiments of an oblique incidence interferometer according to the present invention will be described below with reference to the drawings. In the drawings, a double-headed arrow schematically illustrates a linearly polarized light component parallel to a sheet of the drawing and a double circle symbol denotes a linearly polarized light component perpendicular to a sheet of the drawing.

### First Embodiment

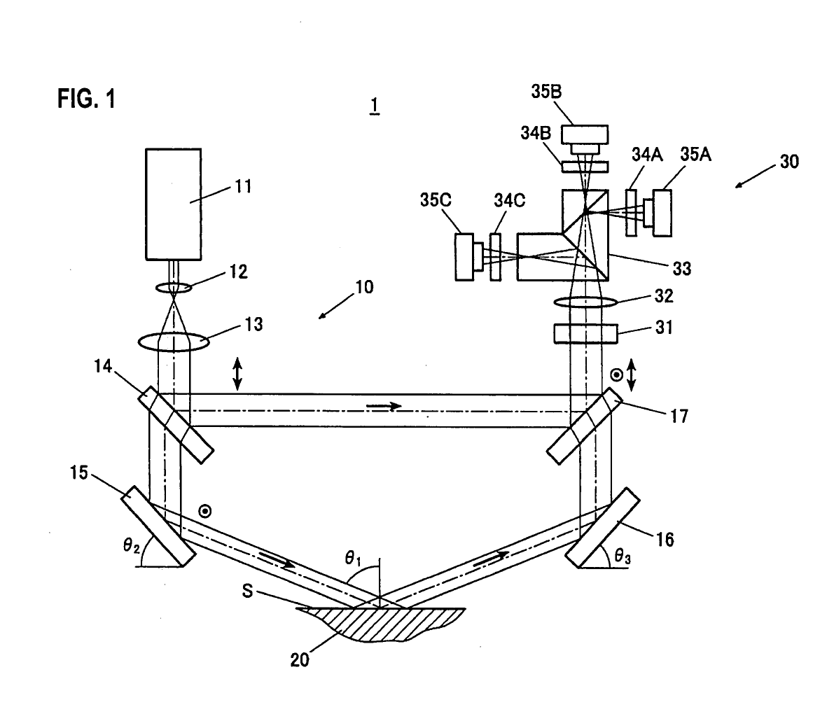

FIG. 1 illustrates a schematic configuration of an oblique incidence interferometer 1 according to a first embodiment.

As illustrated in FIG. 1, the oblique incidence interferometer 1 includes an irradiation section 10 and a detection section 30.

The irradiation section 10 includes a light source 11, lenses 12 and 13, a beam dividing unit 14, a first beam folding unit 15, a second beam folding unit 16, and a beam combining unit 17.

The light source 11 emits coherent light toward the beam dividing unit 14. According to the first embodiment, the light source 11 is arranged such that a measurement object surface S of a measurement object 20 is irradiated with the light substantially perpendicularly to the measurement object surface S.

The light source 11 may preferably emit laser light, such as He—Ne laser, having favorable coherence such that when entering an optical system of the oblique incidence interferometer, a component ratio between P-polarized light and S-polarized light does not vary with time.

The light emitted from the light source 11 enters the beam dividing unit 14 after being converted into light collimated with a larger beam diameter by the lenses 12 and 13.

The beam dividing unit 14 divides the collimated light emitted from the light source 11 via the lenses 12 and 13 into two polarized beams.

Specifically, the beam dividing unit 14 includes, for example, a polarization beam splitter. The polarization beam splitter is configured to sandwich a polarizing film having polarization dependency, for example, with two optical glass plates. The polarizing film has optical characteristics in that among the collimated light components, the S-polarized light is reflected therefrom while the P-polarized light is passed therethrough, and the polarizing film divides the light obliquely incident in the polarizing film into both polarized light components by causing the P-polarized light to pass therethrough and the S-polarized light to be reflected therefrom. On the polarizing film, the polarization beam splitter divides incident light having various polarized light components into two divided beams having polarizing directions which are perpendicular to each other (vertical linear polarized light and horizontal linear polarized light).

A rectangular parallelepiped polarization beam splitter formed by sandwiching the polarizing film with two rectangular prisms may be also used as the beam dividing unit 14.

The two beams divided by the beam dividing unit 14 proceed straight toward the first beam folding unit 15 and the beam combining unit 17, respectively. In the following description, among the beams divided by the beam dividing unit 14, a beam proceeding toward the first beam folding unit 15 is assumed to be a measurement beam, with which the measurement object 20 is irradiated, and the beam proceeding toward the beam combining unit 17 is assumed to be a reference beam being a measurement reference.

The first beam folding unit 15 and the second beam folding unit 16 include reflection mirrors, for example, and may change the optical path of incident light by reflecting the incident light.

The first beam folding unit 15 folds the measurement beam, and causes the measurement beam that is divided by the beam dividing unit 14 to be incident on the measurement object surface S at a predetermined angle.

Specifically, the first beam folding unit 15 is designed such that the measurement beam from the beam dividing unit 14 is caused to enter the measurement object surface S at a predetermined incident angle θ1 to the normal of the measurement object surface S. The incident angle θ1 can be adjusted by changing an inclination (referred to as a set up angle θ2 hereinafter) of the first beam folding unit 15 to the measurement object surface S.

That is, when the set up angle θ2 is reduced, the incident angle θ1 is increased and when the arrangement angle θ2 is increased, the incident angle θ1 is reduced.

At this time, a specimen support (not shown) carrying the measurement object 20 thereon is vertically movable, so that the incident position of light on the measurement object surface S can be adjusted.

The second beam folding unit 16 causes a measurement beam reflected from the measurement object surface S to enter the beam combining unit 17 by folding the measurement beam.

Specifically, the second beam folding unit 16 causes a measurement beam reflected from the measurement object 20 to reflect toward the beam combining unit 17 such that an optical axis of the measurement beam is overlapped with an optical axis of reference beam reflected by the beam combining unit 17.

In the same way as the design of the first beam folding unit 15, the second beam folding unit 16 can also set up the inclination (set up angle θ3) to the measurement object surface S.

The first beam folding unit 15 and the second beam folding unit 16 may have ideal component arrangements when the setting points in a height direction are the same and the set up angle θ2 is identical with the set up angle θ3.

The first beam folding unit 15 and the second beam folding unit 16 may also be configured to cause the setting points in the height direction to be changed.

If the first beam folding unit 15 and the second beam folding unit 16 are configured in the above manner, the arrangement can be adjusted such that light is incident at the same position on the measurement object surface S independently of the set up angles q2 and q3. This is accomplished, for example, by raising the setting points when the set up angles q2 and q3 are increased, and by lowering the setting points when the set up angles q2 and q3 are reduced.

The beam combining unit 17 combines the measurement beam folded by the second beam folding unit 16 with the reference beam.

Specifically, the beam combining unit 17 is formed of a polarization beam splitter, etc., in the same way as the configuration of the beam dividing unit 14. The beam combining unit 17 combines both the measurement beam and the reference beam such that the optical axis of the measurement beam is overlapped with the axis of the reference beam to feed the combined waves to the detection section 30.

The detection section 30 includes a quarter wave plate 31, a lens 32, a tripartite prism (second beam dividing unit) 33, polarizing plates 34A to 34C, and image pickup devices 35A to 35C.

The quarter wave plate 31 is arranged on an incident side of the tripartite prism 33 to convert the combined light from the beam combining unit 17 into circularly polarized light.

The tripartite prism 33 is configured by bonding planes of three prisms together, for example, and divides the combined light into three divided beams by causing the light to pass through or to reflect from the bonded planes.

The polarizing plates 34A to 34C and the image pickup devices 35A to 35C are arranged to respectively correspond to the beams divided by the tripartite prism 33 in three directions different from each other. The polarizing plates 34A to 34C are arranged such that the directions of polarizing axes differ from each other. The images of interference fringes, with phases shifted by angular degrees different from each other by causing light to pass through the polarizing plates 34A to 34C, are picked up by the image pickup devices 35A to 35C.

The functions of the oblique incidence interferometer 1 configured in such a manner will be described.

The light source 11 emits coherent light toward the beam dividing unit 14.

The light emitted from the light source 11 is collimated via the lenses 12 and 13 to enter the beam dividing unit 14. The incident light is divided by the beam dividing unit 14 into two polarized beams perpendicular to each other in polarizing directions so as to proceed straightly toward the first beam folding unit 15 and the beam combining unit 17, respectively.

One of the divided beams is used as the measurement beam, and is folded by the first beam folding unit 15, then the measurement object surface S of the measurement object 20 is irradiated at a predetermined angle thereto with the measurement beam. The measurement beam reflected from the measurement object surface S is again folded by the second beam folding unit 16 to enter the beam combining unit 17.

On the other hand, the other beam divided by the beam dividing unit 14 is used for the reference beam to enter the beam combining unit 17.

Then, the measurement beam from the second beam folding unit 16 is combined with the reference beam from the beam dividing unit 14 by the beam combining unit 17.

The combined beam combined by the beam combining unit 17 is converted by the quarter wave plate 31 into circularly polarized light. The beam becoming the circularly polarized light is divided by the tripartite prism 33 into beams in three directions. The divided beams in the three directions respectively pass through the polarizing plates 34A to 34C that are arranged such that polarizing axial directions differ from each other to form interference fringes with phases shifted by angular degrees different from each other. Then, images of the interference fringes with shifted phases are picked up by the image pickup devices 35A to 35C, respectively.

The oblique incidence interferometer 1 also includes a computing unit (not shown) to obtain a surface shape of the measurement object 20 by computing processing according to a known phase shift method on the basis of the interference fringe images picked up by the image pickup devices 35A to 35C.

As described above, the oblique incidence interferometer 1 according to the first embodiment includes the light source 11 configured to emit coherent light; the beam dividing unit 14 configured to divide the coherent light from the light source 11 into the measurement beam and the reference beam, polarizing directions of both beams being perpendicular to each other; the first beam folding unit 15 configured to fold the measurement beam divided by the beam dividing unit 14 and to cause the beam to be incident on the measurement object surface S at a predetermined angle; the second beam folding unit 16 configured to fold the measurement beam reflected from the measurement object surface S; and the beam combining unit 17 configured to combine the measurement beam folded by the second beam folding unit 16 with the reference beam.

That is, because of an optical system in which the light from the light source is divided by the beam dividing unit 14 into two beams having polarizing directions which are perpendicular to each other to use one as the measurement beam and the other as the reference beam, interference fringes with a high extinction ratio and a high signal-to-noise ratio can be obtained, causing the measurement to have higher accuracy. Since the optical path of the measurement beam can also be changed with the first beam folding unit and the second beam folding unit, the oblique incidence interferometer can be miniaturized.

Hence, an oblique incidence interferometer can be obtained that reconciles the apparatus miniaturizing with the measurement accuracies.

With the first beam folding unit 15 and the second beam folding unit 16, the incident angle θ1 of the light, with which the measurement object surface S is irradiated, can also be changed, so that the apparatus can react to various surface shapes of the measurement object 20.

Because none of optical components in the optical system is arranged above the measurement object surface S, a degree of freedom of arrangement of optical components is increased, so that risks of apparatus breakage due to difficult arrangement of optical components can be reduced, improving practicality and usability.

There also is provided a tripartite prism 33, which is configured to divide the combined light combined by the beam combining unit 17 into a plurality of divided beams. Also, a plurality of the image pickup devices 35A to 35C are configured to pick up a plurality of interference fringe images formed by the plurality of divided beams, respectively. The quarter wave plate 31 is arranged on the incident side of the tripartite prism 33. A plurality of the polarizing plates 34A to 34C are arranged on the imaging plane sides of the plurality of the image pickup devices 35A to 35C such that the directions of polarizing axes differ from each other.

Hence, three pieces or more of interference images that are required for analyzing interference fringes by a phase shift method can be instantly picked up without having mechanical movable parts, reducing effects of vibrations and air fluctuations to improve the robustness of the measurement.

### Second Embodiment

The second embodiment of the present invention will be described focusing mainly on points that are different from the first embodiment. Like reference numerals designate like components common to the first embodiment and the description thereof is omitted.

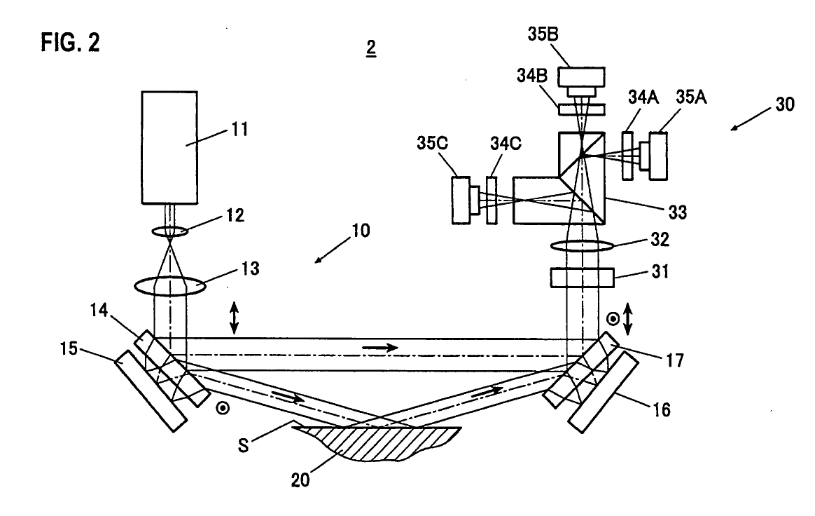

FIG. 2 illustrates a schematic configuration of an oblique incidence interferometer 2 according to the second embodiment.

As illustrated in FIG. 2, in the oblique incidence interferometer 2, the beam dividing unit 14 and the first beam folding unit 15 as well as the beam combining unit 17 and the second beam folding unit 16 may be arranged closely to each other, such that the measurement beam passes through the beam dividing unit 14 and the beam combining unit 17 multiple times.

Specifically, the measurement beam divided by the beam dividing unit 14 again passes through the beam dividing unit 14 after being reflected by the first beam folding unit 15, so that the measurement object surface S is irradiated with the measurement beam.

The measurement beam reflected from the measurement object surface S is folded by the second beam folding unit 16 after passing through the beam combining unit 17, and the measurement beam again enters the beam combining unit 17 to be overlapped with the reference beam. Then, the beam is brought in the detection section 30 in the same way as described in the first embodiment.

Hence, in the optical path arrangement according to the second embodiment, the measurement beam passes through the beam dividing unit 14 and the beam combining unit 17 two times, respectively (four times in total), so that the proportion of undesirable polarized light components (noise) included in the measurement beam due to the functions of the beam dividing unit 14 and the beam combining unit 17 is reduced.

In the same way as the configuration of the first embodiment, the incident angle of the measurement beam to the measurement object surface can be adjusted.

As described above, according to the oblique incidence interferometer 2 of the second embodiment, while the same effect as the effect of the first embodiment can be naturally obtained, since a number of passing times through the beam dividing unit 14 and the beam combining unit 17 is doubled, a proportion of noise included in the measurement beam is reduced and an extinction ratio can be increased to be higher than the extinction ratio of the oblique incidence interferometer 1 according to the first embodiment. Accordingly, the signal-to-noise ratio of the interference fringes obtained in the detection section 30 can be increased in the second embodiment.

Also, the distances between the beam dividing unit 14 and the first beam folding unit 15 and between the beam combining unit 17 and the second beam folding unit 16 are reduced, so that while the entire apparatus can be reduced in size, the effect of air fluctuations can be reduced because the distance between the reference beam and the measurement beam is reduced.

### Third Embodiment

The third embodiment of the present invention will be described focusing mainly on points that are different from the first embodiment. Like reference numerals designate like common components and the description thereof is omitted.

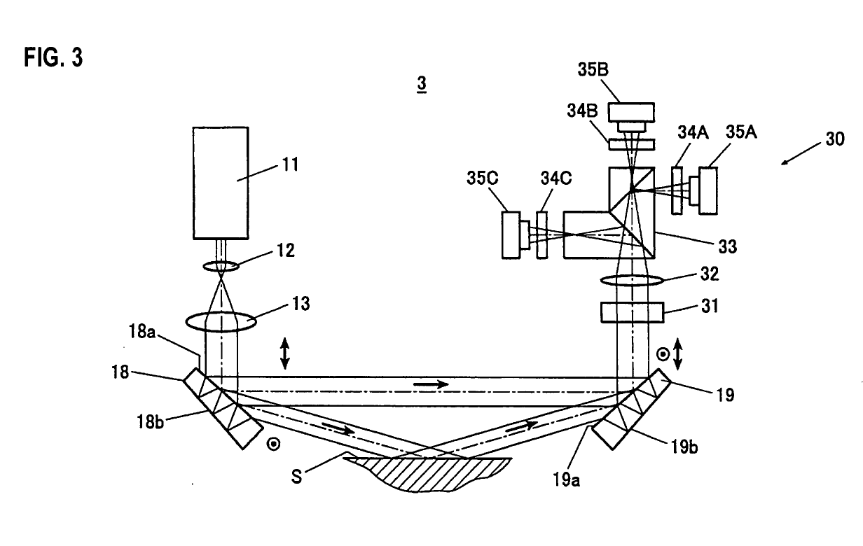

FIG. 3 illustrates a schematic configuration of an oblique incidence interferometer 3 according to the third embodiment.

As illustrated in FIG. 3, in the oblique incidence interferometer 3, the beam dividing unit 14 and the first beam folding unit 15 are included in a single optical component while the beam combining unit 17 and the second beam folding unit 16 are included in a single optical component. The single optical component may use a wedge element (referred to as an optical wedge hereinafter), for example, in which one planar surface is slightly inclined with respect to an opposing other planar surface.

Specifically, the oblique incidence interferometer 3 includes optical wedges 18 and 19 instead of the beam dividing unit 14, the first beam folding unit 15, the second beam folding unit 16, and the beam combining unit 17 according to the first embodiment.

The optical wedge 18 includes an upper planar surface 18a serving as a beam dividing unit and a bottom planar surface 18b serving as a first beam folding unit.

The optical wedge 19 includes an upper planar surface 19a serving as a beam combining unit and a bottom planar surface 19b serving as a second beam folding unit.

Accordingly, the light entering the optical wedge 18 is divided by the upper planar surface 18a into the measurement beam and the reference beam, in which the measurement beam again passes through the upper planar surface 18a after being reflected by the bottom planar surface 18b, so that the measurement object surface S is irradiated with the measurement beam.

Also, the measurement beam reflected from the measurement object surface S is folded by the bottom planar surface 9b after firstly passing through the upper planar surface 19a of the optical wedge 19 and again enters the upper planar surface 19a to be overlapped with the reference beam. Thereafter, in the same way as the first and second embodiments, the beam is brought in the detection section 30.

As described above, according to the oblique incidence interferometer 3 of the third embodiment, while the same effect as the effects of the first and second embodiments can be naturally obtained, by introducing single optical elements, each with one planar surface serving as the beam dividing unit 14 or the beam combining unit 17 and the other planar surface serving as the first beam folding unit 15 or the second beam folding unit 16, a more simplified optical system can be configured, and the same optical path as the optical path of the second embodiment can be configured while reducing a number of optical elements.

Hence, when a surface shape of the measurement object surface S is known and generally constant, an optimum incident angle to the measurement object surface S can be selectively fixed.

According to the first to third embodiments described above, the optical path of the measurement beam is folded using two beam folding units; however, a number of the beam folding units is not limited thereto.

The light source 11 may preferably use a light source outputting the laser light linearly polarized in P-polarized light or S-polarized light. When configuring the light source in such a manner, an amount of light, with which the measurement object surface S of the measurement object 20 is irradiated, can be regulated in accordance with roughness of the measurement object surface S by adjusting a polarizing angle to the beam dividing unit 14 (polarization beam splitter). When the roughness of the measurement object surface S is large, for example, the reflection efficiency is reduced, so that an amount of passing through light may be increased.

Exemplary embodiments of the present invention have been described above. However, the invention is not limited to these embodiments, so that various modifications, additions, and substitutions can be made within the scope of the invention.

What is claimed is:

1. An oblique incidence interferometer configured to measure a shape of a measurement object surface by irradiating the measurement object surface with coherent light in an oblique direction relative to a normal of the measurement object surface to cause a measurement beam reflected from the measurement object surface to interfere with a reference beam, the oblique incidence interferometer comprising:
a light source configured to emit the coherent light;
a beam dividing unit configured to divide the coherent light from the light source into the measurement beam and the reference beam, polarizing directions of the measurement and reference beams being perpendicular to each other;
a first beam folding unit configured to fold the measurement beam divided by the beam dividing unit to cause the folded measurement beam to be incident on the measurement object surface at a predetermined angle relative to the measurement object surface;
a second beam folding unit configured to fold the measurement beam reflected by the measurement object surface toward the reference beam; and
a beam combining unit configured to combine the measurement beam folded by the second beam folding unit with the reference beam.

2. The oblique incidence interferometer according to claim 1, wherein
the beam dividing unit and the first beam folding unit, as well as the beam combining unit and the second beam folding unit, are arranged closely to each other;
the measurement beam folded by the first beam folding unit again passes through the beam dividing unit so as to enter the measurement object surface; and
the measurement beam reflected by the measurement object surface is folded by the second beam folding unit after passing through the beam combining unit so as to again enter the beam combining unit.

3. The oblique incidence interferometer according to claim 2, wherein the beam dividing unit and the first beam folding unit are included in a single optical component, while the beam combining unit and the second beam folding unit are also included in a single optical component.

4. The oblique incidence interferometer according to claim 1, wherein the beam dividing unit and the beam combining unit are polarization beam splitters.

5. The oblique incidence interferometer according to claim 3, wherein the single optical component is an optical wedge.

6. The oblique incidence interferometer according to claim 1, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.

7. The oblique incidence interferometer according to claim 2, wherein the beam dividing unit and the beam combining unit are polarization beam splitters.

8. The oblique incidence interferometer according to claim 2, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.

9. The oblique incidence interferometer according to claim 3, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.

10. The oblique incidence interferometer according to claim 4, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.

11. The oblique incidence interferometer according to claim 5, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.

12. The oblique incidence interferometer according to claim 7, further comprising:
a second beam dividing unit configured to divide the combined beam combined by the beam combining unit into a plurality of divided beams;
a plurality of image pickup devices configured to respectively pick up a plurality of interference fringe images, which are respectively formed by the plurality of divided beams;
a quarter wave plate arranged on an incident side of the second beam dividing unit; and
a plurality of polarizing plates arranged on an imaging plane sides of the plurality of image pickup devices such that directions of polarizing axes of the polarizing plates differ from each other.
